(19) United States
(12) Patent Application Publication
(10) Pub. No.: US 2011/0132950 A1
(43) Pub. Date: Jun. 9, 2011

(54) Seat Belt Attachment

(76) Inventor: Karen Culver, Windsor, CA (US)

(21) Appl. No.: 12/630,027

(22) Filed: Dec. 3, 2009

(51) Int. Cl. B60R 11/00

(52) U.S. Cl. 224/485

(57) ABSTRACT

A seat belt accessory includes a base plate having upper and lower ends and opposed side edges extending between the upper and lower ends, the base plate having a generally planar configuration. The base plate includes opposed front and rear surfaces that are generally planar. A belt clip is attached to the upper end of the base plate. A plurality of holder clips is attached to respective side edges of the base plate, the plurality of holder clips being configured to removably secure the electronic device adjacent the front surface of the base plate.

### CROSS REFERENCE TO RELATED APPLICATION

This non-provisional patent application claims the benefit of provisional application Ser. No. 61/115,650 filed on Dec. 6, 2008, titled Universal Seat Belt Attachment.

### BACKGROUND OF THE INVENTION

This invention relates generally to seat belt accessories and containment devices in general and, more particularly, to a seat belt attachment that is removably securable to a seatbelt and that itself is configured to removably contain other objects such as electronic devices.

Many jurisdictions in the United States are placing legal restrictions on operation of a cell phone by the operator of an automobile. In other words, a driver may be prohibited from using his hands to dial or hold a mobile telephone while driving. In these instances, a vehicle operator may be required to install special hardware such that the mobile phone may be operated by way of a remote microphone that does not need to be held by the user's hand. This may be accomplished by attaching a microphone to the vehicle's visor and the speaker may be the vehicle's radio or a separate remote speaker.

Although assembly effective for their intended purposes, devices such as those described above may include permanent mounting of components that are not easily removable for remote use by the motorist upon reaching a destination. In other words, special hardware may need to be installed that cannot then be used in the traditional manner of a mobile telephone once the destination has been reached.

Therefore, it would be desirable to have an accessory that may be conveniently mounted to a driver's seatbelt that enables a call to be initiated and engaged in without prolonged use of the driver's hands. Further, it would be desirable to have a seat belt attachment that would allow a traditional cell phone to be removably held at a selected position on the seat belt and removed when the driver exits the vehicle. In addition, it would be desirable to have a seat belt attachment that may itself remain attached to a seatbelt after an electronic device has been removed.

### SUMMARY OF THE INVENTION

A seat belt accessory that is removably attachable to a seat belt for holding an electronic device includes a base plate having upper and lower ends and opposed side edges extending between the upper and lower ends, the base plate having a generally planar configuration. The base plate includes opposed front and rear surfaces that are generally planar. A belt clip is attached to the upper end of the base plate. A plurality of holder clips is attached to respective side edges of the base plate, the plurality of holder clips being configured to removably secure the electronic device adjacent the front surface of the base plate.

Therefore, a general object of this invention is to provide a seat belt accessory that is removably attachable to an automobile seat belt and that removable secures an electronic device.

Another object of this invention is to provide a seat belt accessory, as aforesaid, that enables a mobile phone to be used with a relatively minimal amount of use of a driver's hands.

Still another object of this invention is to provide a seat belt accessory, as aforesaid, that allows for convenient removal of the electronic device even if the accessory remains attached to a seat belt and that itself may be selectively removed from the seat belt.

Yet another object of this invention is to provide a seat belt accessory, as aforesaid, that is user friendly to use and cost-effective to manufacture.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a front perspective view of a seat belt accessory according to one embodiment of the present invention;

FIG. 2 is a rear perspective view of the seat belt accessory as in FIG. 1;

FIG. 3 is a front perspective view of the seat belt accessory as in FIG. 1 in use with a mobile telephone;

FIG. 4 is an exploded view of the seat belt accessory as in FIG. 3;

FIG. 5 is front view of the seat belt accessory as in FIG. 1;

FIG. 6 is a side view of the seat belt accessory as in FIG. 5;

FIG. 7 is a top view of the seat belt accessory as in FIG. 5;

FIG. 8 is a front view of the seat belt attachment in use upon a seat belt;

FIG. 9 is a rear isolated view of the seat belt attachment in upon a seat belt as in FIG. 8;

FIG. 10 is an isolated view on an enlarged scale of the seat belt attachment removably secured to a seat belt;

FIG. 11 is a front perspective view of a seat belt accessory according to a another embodiment of the present invention with the malleable holder clips in a retracted configuration; and

FIG. 12 is another perspective view of the seat belt accessory as in FIG. 11 with the holder clips in an extended configuration.

### DESCRIPTION OF THE PREFERRED EMBODIMENT

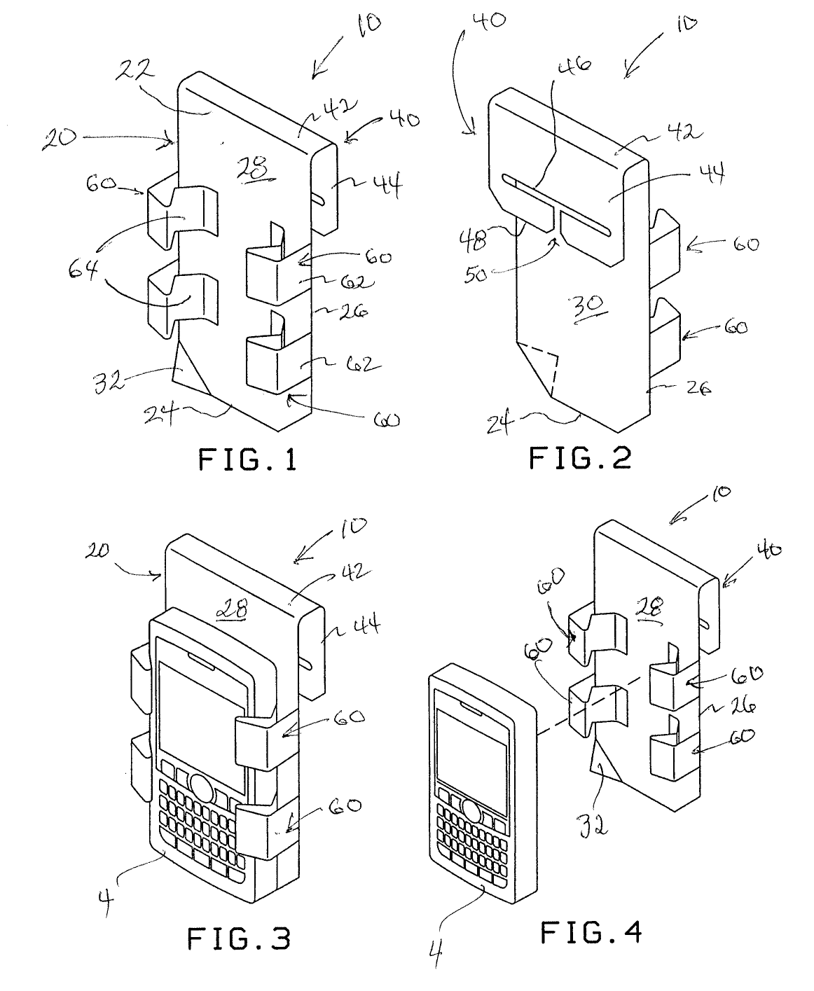

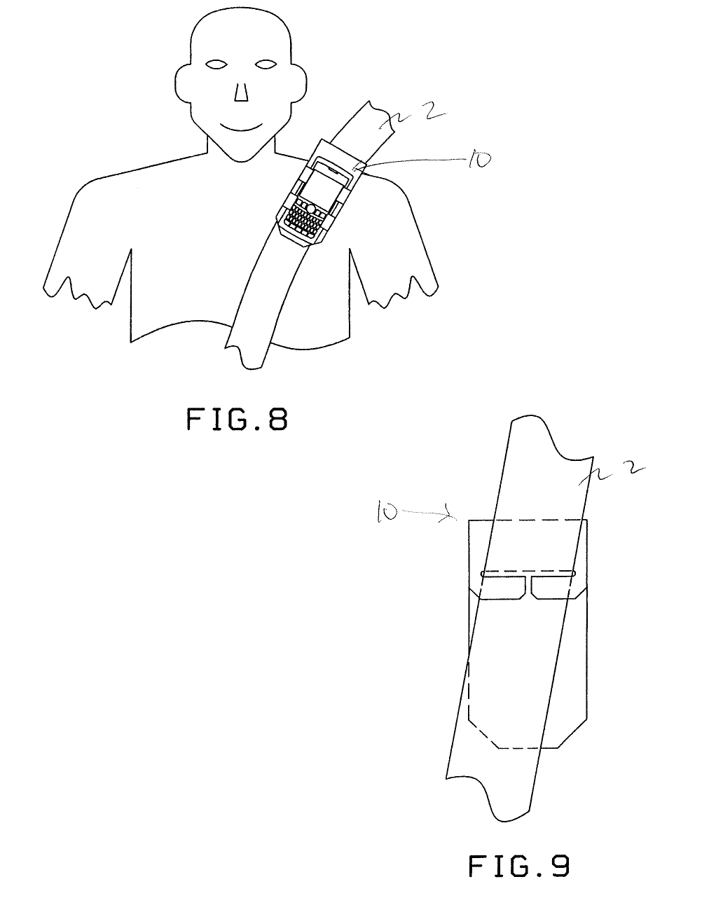

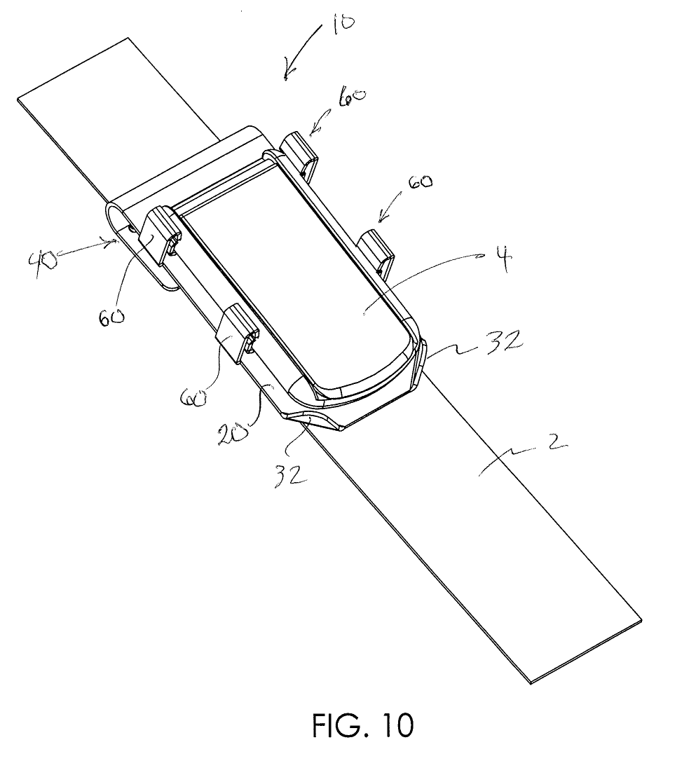

A seat belt accessory according to the present invention will now be described in detail with reference to FIGS. 1 to 12 of the accompanying drawings. The seat belt accessory 10 includes a base plate 20, a belt clip 40, and a plurality of holder clips 60 attached to the base plate 20 for selectively and removably holding an electronic device 4.

More particularly, the base plate 20 includes upper 22 and lower 24 ends with opposed side edges 26 extending therebetween. In the embodiment shown in FIGS. 1-10, the base plate 20 includes a generally rectangular configuration in which the side edges 26 have a linear configuration and the base plate 20 is generally rectangular. The base plate 20 also presents opposed front 28 and rear 30 surfaces that are each generally planar and therefore generally parallel to one another.

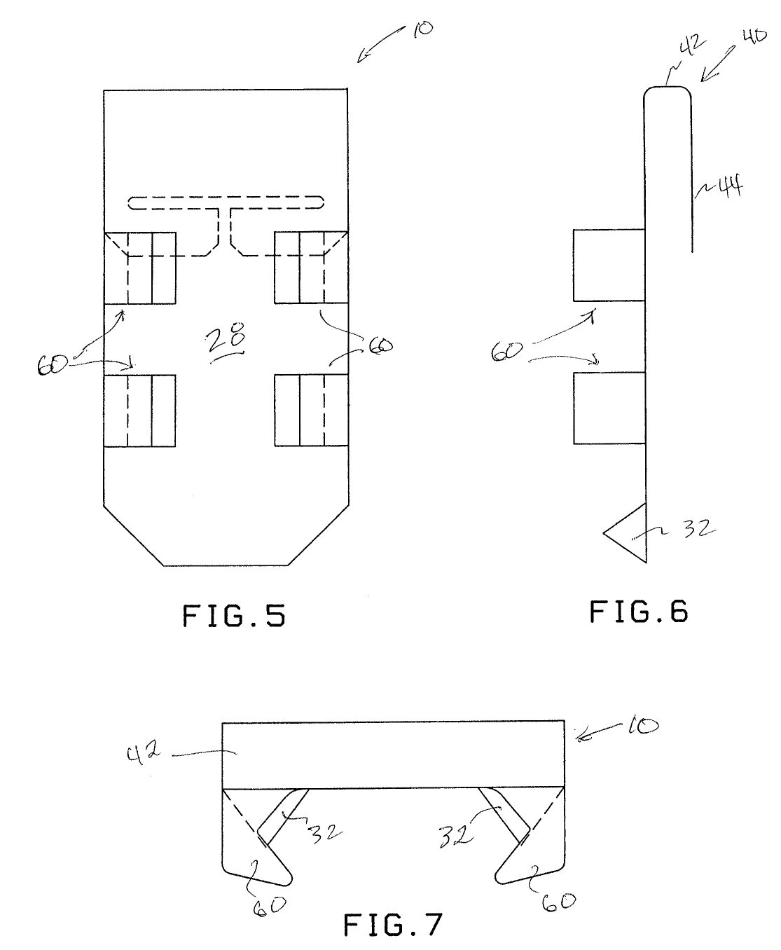

A belt clip 40 is fixedly attached to the upper end 22 of the base plate 20 and is configured such that the base plate 20 may be removably coupled to an automobile seatbelt 2. More particularly, the belt clip 40 includes a first portion 40 that extends rearwardly away from the upper end 22 of the base plate 20. The belt clip 40 includes a second portion 42 extending downwardly from the first portion 40 and may be situated generally parallel to the rear surface 30 of the base plate 20. As shown in FIG. 6, the first portion 40 may be generally perpendicular relative to the rear surface 30 of the base plate 20 and the second portion 42 may be generally perpendicular to the first portion 40. The base plate 20 and the belt clip 40, viewed together, present an inverted U-shaped configuration. The second portion 42 defines a slit 46 extending substantially between its opposed side edges, the slit 46 being connected to an opening 50 at a lower edge of the second portion 42, as best shown in FIG. 2.

The plurality of holder clips 60 are attached to the opposed side edges 26 of the base plate 20. The plurality of holder clips 60 are configured to removably secure an electronic device 4 at a position adjacent to or in contact with the front surface of the base plate 20. More particularly, each holder clip 60 includes an outer portion 62 having an L-shaped configuration attached to the base plate 20 and an inner portion 64 connected to the outer portion 62. Each outer portion 62 includes a flexible configuration that is biased toward an opposed holder clip inner portion 64 so as to secure the electronic device between respective opposed inner portions 64. In other words, the electronic device 4 may be pressed against opposed inner portions 64 and they will spread apart while being biased against each side to hold the device securely.

The lower end 24 of the base plate 20 includes or is configured to present a lip 32 for preventing an electronic device positioned on the front surface 28 of the base plate 20 from sliding downwardly thereon. Preferably, the lip 32 extends outwardly away from the front surface 28 of the base plate 20. It is understood that the lip 32 may not extend completely between base plate side edges 26.

In use, the seat belt accessory 10 may be removably attached to an automobile seatbelt 2 as described above. An electronic device 4 such as a mobile telephone may be removably secured to the holder clips 60. The belt clip 40 allows the accessory 10 to be slidably positioned as desired such that the mobile telephone may be conveniently dialed and used by a driver of the vehicle. It is understood that the mobile telephone should be used in a “speaker” mode such that incoming audio signals are broadcast through a speaker other than the telephone earpiece. This may be through a cable to the driver's ear, through the vehicle's radio speakers, or through a speaker on the phone itself.

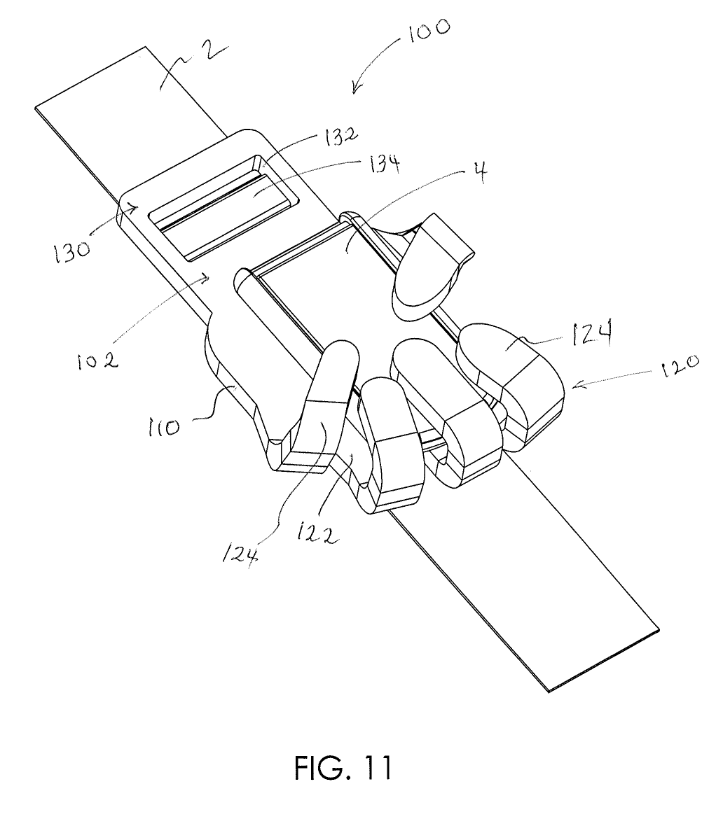

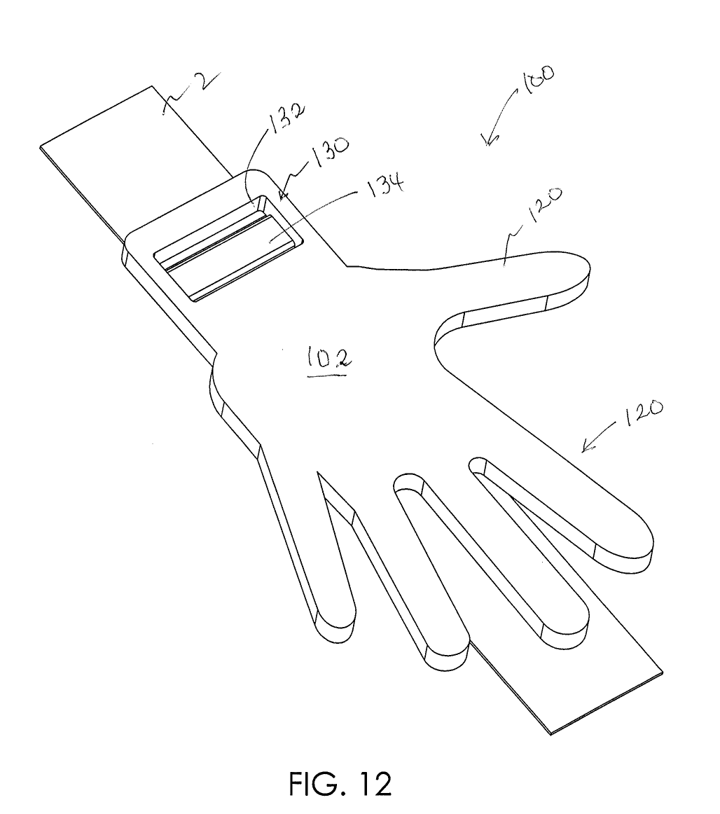

A seat belt accessory 100 according to another embodiment of the present invention is shown in FIGS. 11 and 12 and includes a construction that is substantially similar to the seat belt accessory 10 described previously except as specifically noted below. In this embodiment, the side edges 110 of the base plate 102 may extend outwardly such that the base plate 102 has the appearance of a human hand. It is understood that the base plate 102 may also be configured in other irregular shapes and represent cartoon characters, fanciful figures, or other novelty items. In addition, each of the plurality of holder clips 120 may include a semi-flexible/malleable construction that is movable between extended and retracted configurations. Each holder clip 120 is positioned substantially coplanar with the base plate 102 at the extended configuration (FIG. 12). At least a portion of each holder clip 120 is positioned substantially parallel to the base plate 102 when at the retracted configuration (FIG. 11) such that an electronic device 4 may be held securely between the retracted portion and the base plate 102. More particularly, each of the holder clips 120 includes a first portion 122 having a generally rigid construction extending outwardly from the base plate 102 in a coplanar relationship therewith and a second portion 124 movable between an extended configuration coplanar with a respective first portion 122 and a retracted configuration substantially parallel to a respective first portion, such that the electronic device 4 may be removably secured between the respective first and second portions at the retracted configuration. It is understood that the holder clips 120 may include a metal wire or spring steel construction that is semi-flexible and that holds its position whether extended or retracted until again manipulated/bent by a user. Each holder clip may be covered with a soft flexible material such as rubber.

The seat belt accessory 100 according to the embodiment shown in FIGS. 11 and 12 includes a belt clip 130 that is situated in-line with the base plate 102. The belt clip 130 defines an opening 132 and includes a crossbar 134 positioned within the opening 132 that is configured to receive a seatbelt thereabout. In use, a seatbelt may be threaded above and below the crossbar 134 such that the entire seat belt accessory 100 may slide along the seatbelt to a desired position.

It is understood that while certain forms of this invention have been illustrated and described, it is not limited thereto except insofar as such limitations are included in the following claims and allowable functional equivalents thereof. Additional embodiments may be apparent to one of ordinary skill in the art as a result of the teaching of the present application.

What is claimed is:

1. A seat belt accessory that is removably attachable to a seat belt for holding an electronic device, comprising:
a base plate having upper and lower ends and opposed side edges extending between said upper and lower ends, said base plate having a generally planar configuration;
wherein said base plate includes opposed front and rear surfaces;
a belt clip fixedly attached to said upper end of said base plate;
a plurality of holder clips attached to respective side edges of said base plate, said plurality of holder clips being configured to removably secure the electronic device adjacent said front surface of said base plate.

2. The seat belt accessory as in claim 1, wherein each of said plurality of holder clips includes:
an outer portion having an L-shaped configuration attached to said base plate;
an inner portion connected to said outer portion and having a flexible configuration that is biased toward an opposed holder clip inner portion, whereby to secure the electronic device between respective opposed holder clips.

3. The seat belt accessory as in claim 1, wherein each said holder clip includes a flexible configuration that is biased to move toward an opposed holder clip, whereby to removably secure the electronic device between respective opposed holder clip.

4. The seat belt accessory as in claim 1, wherein said belt clip includes a first portion that extends rearwardly from said upper end of said base plate and a second portion extending downwardly from said first portion, said second portion being generally parallel to said rear side of said base plate.

5. The seat belt accessory as in claim 4, wherein said base plate and said belt clip together include a generally inverted U-shaped configuration.

6. The seat belt accessory as in claim 4, wherein said second portion defines a slit that is operatively connected to an opening in a lower edge of said second portion of said belt clip such that the seat belt is removably inserted through said opening into said slit for slidable movement therein.

7. The seat belt accessory as in claim 1, wherein said lower end of said base plate includes a lip extending away from said base plate front surface, said lip having a configuration to prevent the electronic device from sliding downwardly when positioned adjacent said base plate front surface.

8. The seat belt accessory as in claim 1, wherein each of said plurality of holder clips includes a semi-flexible construction movable between extended and retracted configurations, said plurality of holder clips being positioned substantially coplanar with said base plate when at said extended configuration and at least a portion of each said holder clip being positioned substantially parallel to said base plate front surface when at said retracted configuration so as to removably secure the electronic device between said plurality of holder clips and said base plate front surface.

9. The seat belt accessory as in claim 1, wherein each of said plurality of holder clips includes a first portion having a generally rigid construction extending outwardly from said base plate in a coplanar relationship therewith and a second portion movable between an extended configuration coplanar with a respective first portion and a retracted configuration substantially parallel to a respective first portion, whereby the electronic device is removably secured between said respective first and second portions at said retracted configurations.

10. The seat belt accessory as in claim 1, wherein said belt clip is inline with said base plate.

11. The seat belt accessory as in claim 10 wherein said belt clip defines an opening and includes a crossbar positioned in said opening that is configured to receive a seat belt thereabout, said belt clip configured to selectively slide along said seat belt when said seat belt is received about said crossbar.

12. The seat belt accessory as in claim 11, wherein said lower end of said base plate includes a lip extending away from said base plate front surface, said lip having a configuration to prevent the electronic device from sliding downwardly when positioned adjacent said base plate front surface.
